(19) United States
(12) Patent Application Publication
(10) Pub. No.: US 2008/0143243 A1
(43) Pub. Date: Jun. 19, 2008

(54) Planar or Substantially Planar Luminous Structure

(75) Inventors: Guillaume Auday, Bussiere-St-George (FR); Jingwei Zhang, Massy (FR); Didier Duron, Boulogne Billancourt (FR); Sereyvuth Chan, Breda (NL)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 11/816,549

(22) PCT Filed: Feb. 22, 2006
(86) PCT No.: PCT/FR2006/050156

§ 371 Date: Oct. 5, 2007

(30) Foreign Application Priority Data
Feb. 22, 2005 (FR) 0550489

(51) Int. Cl. H01J 1/62; H02H 3/00

(52) U.S. Cl. 313/498; 361/1

(57) ABSTRACT

A flat or substantially flat luminous structure. First and second walls face each other and define an internal space that includes a light source. First and second electrodes for the light source generate electric field lines with at least one component perpendicular to the first and second electrodes, the first electrode supplied or configured to be supplied with a high frequency electromagnetic signal. As an outer covering for the first electrode, an electrical safety system includes an electrical conductor separated from the first electrode by a dielectric, the conductor connected or configured to be connected to a power supply with a potential V and/or with a frequency f, these being adjusted so that the peak value of the external leakage current is equal to 2 mA or less if f is zero, or equal to 0.7 mA or less if f is nonzero.

The invention relates to the field of luminous structures and more particularly to a flat or substantially flat luminous structure with first and second walls facing each other and defining an internal space that includes a light source, first and second electrodes for the light source, which generate electric field lines with at least one component perpendicular to the first and second electrodes, at least the first electrode being supplied or capable of being supplied with a high-frequency electromagnetic signal.

Among known flat luminous structures are flat lamps that can be used as a decorative or architectural luminaire or that can serve for the backlighting of liquid-crystal screens. These flat lamps are typically formed from two sheets of glass held together with a small gap between them, generally of less than a few millimeters, and hermetically sealed so as to contain a gas under reduced pressure, in which an electrical discharge produces radiation generally in the ultraviolet range, which excites a photoluminescent material, which then emits visible light.

Document WO 2004/015739 A2 thus discloses a flat discharge lamp comprising:
two walls in the form of glass sheets held together so as to be parallel and defining a gas-filled internal space, the faces of which, turned toward the internal space, are coated with a photoluminescent material;
two electrodes in the form of a uniform layer covering the respective two walls to the outside of the internal space, these electrodes thus generating electric field lines with at least one component perpendicular to the electrodes; and
two glass sheets joined to the walls via intermediate plastic films.

To supply this type of flat lamp, at least one of the electrodes is at a potential V₀ typically of the order of 1 kV and of high frequency, typically of the order of 1 to 100 kHz, and for example with a power of about 100 W.

The Applicant has found that the insulation capability of the laminating glass/plastic film assembly is unsatisfactory. In particular, the Applicant has found a safety problem with this flat lamp of the prior art whenever a good conducting body, especially metal body, is brought close to the laminated glass in relation to the electrode supplied with high-frequency power.

It is an object of the invention therefore to propose a flat or substantially flat luminous structure, having a high-frequency supply and an electric field with a vertical component, which is safe.

For this purpose, the present invention proposes a luminous structure with first and second walls facing each other and defining an internal space that includes a light source with first and second electrodes for the light source, which generate electric field lines with at least one component perpendicular to the first and second electrodes, the first electrode being supplied or capable of being supplied with a high-frequency electromagnetic signal, this luminous structure according to the invention furthermore including, as an outer covering for the first electrode, an electrical safety system that includes an electrical conductor separated from the first electrode by a dielectric, said conductor being connected or capable of being connected to a power supply with a potential V and/or with a frequency f, these being adjusted so that the peak value of the external leakage current is equal to 2 mA or less if f is zero, or equal to 0.7 mA or less if f is nonzero.

In the structure of the prior art, the leakage current is high as it is proportional to the active area of the first electrode/area of the metal body ratio, to the high frequency, to a high potential and to the power consumed by the lamp.

In the structure according to the invention, the leakage current is limited by adjusting the frequency f and/or the potential V of the electrical conductor in order to make the luminous structure safe.

The potential V and the frequency f, or the product Vf, to be applied to the electrical conductor according to the invention are more limited the higher the ratio of the areas and generally the larger the size of the lamp.

For measuring the leakage current, a metal body will be chosen that preferably has an area equal to that of the first electrode (the most drastic condition) . For a metal object area smaller than that of the electrode, the current is reduced proportionally.

The power may preferably be of the order of 100 W if V is an AC voltage, or even up to 1 kW if V is a DC voltage or even a zero voltage.

The invention applies to any luminous structure supplied with high-frequency power and with a field E having a vertical component (at least two noncoplanar electrodes), especially for any type of light source (plasma gas, luminescent, etc.), of any size, and for any type of use (lamps with unidirectional and/or bi-directional illumination, lamps for decoration, backlighting for screens).

The aim of the invention is for example to produce decorative or architectural elements that are illuminating and/or have a display function (luminous signs, logos or marks), such as especially flat luminaires, luminous, and especially suspended, walls, luminous tiles, etc.

The structure may also constitute an illuminating window and may thus equip any window in a building or means of locomotion (train windows, boat or aircraft cabin windows, roofs, side windows of industrial vehicles, or even portions of rear windows or windshields). It is also conceivable for the structure according to the invention to be fitted into lasing units, internal partitions between rooms in a building, especially in offices, or between two areas/compartments of land, air or sea locomotion means, or to be fitted into shop windows or display counters, or any type of container.

Preferably, the first and second electrodes are associated with the respective first and second walls, which preferably comprise a glass sheet.

A high-performance flat lamp structure is thus maintained.

For assembly, the first electrode will preferably be placed on the least accessible side, for example the ground side in the case of a tile.

Preferably, the dielectric may comprise at least one of the following elements:
a glass element, preferably a glass sheet;
an element made of a polymer material, preferably polyethylene terephthalate (PET), polyvinyl butyl (PVB), ethylene-vinyl acetate (EVA), or polyurethane (PU);
a gas, such as air,
   or a combination of these elements.

Unidirectional illumination is useful for example for illuminating tiles or for the backlighting of LCD display screens.

In the case of bi-directional illumination, all the elements directed more to the outside than the light source of the structure are of course, over a common part, substantially transparent or overall transparent (for example in the form of arrangement of distributed absorbed or reflecting features that let the emitted light pass through them sufficiently), or said elements are translucent.

The dielectric or the electrical conductor may be substantially or overall transparent.

In a first embodiment, the potential V is at ground potential.

Thus the lamp is perfectly isolated, the conductor acting as a shield—the leakage current is zero.

Preferably, the second electrode is connected to ground, and more preferably the conductor and the second electrode are connected possibly to the same point in the supply circuit of the light source.

In this first embodiment, the electrical conductor is for example a layer deposited on said dielectric; for optimum compactness, and simplicity of manufacture, this layer may be protected from scratches by a film and/or by a laminating glass counterpane, and this also prevents the conductor from being torn off.

The electrical conductor may also be a layer deposited on an internal or external face of an additional external dielectric substrate, for example a laminating glass counterpane for increased strength.

The electrical conductor may also be a grid or any arrangement made of conducting material.

Preferably, a reinforced glass sheet includes the dielectric and this grid. Such a structure remains compact and strong.

As a variant, the potential may also be DC, for example equal to 12 V, 24 V or 48 V, and in particular of unlimited value if a glass-type insulation is placed on top.

In a second embodiment, the electrical protection system comprises a covering dielectric (other than air) located on top of the electrical conductor, and the potential V is equal to 400 V or less, preferably 220 V or less and even more preferably 110 V or less and/or the frequency f is equal to 100 Hz or less, preferably 60 Hz or less and even more preferably 50 Hz or less.

The second electrode is also at a potential and a frequency that are substantially identical in order to facilitate the construction.

The potential V is preferably equal to 220 V or less and the frequency f is preferably equal to 50 Hz or less.

This covering dielectric may comprise a sheet of glass preferably with a thickness of 4 mm or less, in order to avoid being excessively thick and/or excessively heavy, and also for cost reasons.

Of course, the smaller the thickness of the dielectric, the more the potential and/or the frequency are to be limited.

In this second embodiment, the dielectric between the first electrode and the electrical conductor is a capacitive insert, which therefore introduces a capacitance that may have to be taken into account when designing the power supply for the light source. It may also be useful to minimize this additional capacitance by choosing a dielectric (a simple or composite dielectric) with the lowest possible relative permittivity and preferably with a limited thickness, with the least cost.

Since the second electrode may also be supplied or capable of being supplied with a high-frequency signal, the luminous structure may preferably include another electrical safety system, for example similar to said electrical safety system described above.

Furthermore, the electrical protection system may form part of an electrically controllable device, preferably one having variable optical properties, such as an electrochromic device or a device with a switchable reflecting or transparent surface.

The electrodes may be in the form of layers. These layers may cover all or part of the facing internal or external faces of the walls. It is possible to provide only certain areas of the surface with one or more walls so as to create predefined luminous regions on any one surface.

For example, the layers may be in the form of an array of parallel bands, bandwidth being between 3 and 15 mm, and a nonconducting space between two adjacent bands, with a width greater than the width of the bands. These layers must therefore be offset by 180° so as to prevent opposed conducting bands of the two walls coming face-to-face. Advantageously, this reduces the effective capacitance of the glass substrates, favoring the power supply of the lamp and its efficiency in lumens/W.

These layers may be made of any conducting material capable of being in the form of a flat element that lets light pass through it, especially one that can be deposited as a thin layer on glass or on a film of plastic, such as PET, as a coating that lets light pass through it. It is preferred to form a coating from a conductive metal oxide or one having electron vacancies, such as fluorine-doped tin oxide or mixed indium tin oxide.

The electrodes may be in the form of grids, for example incorporated into the respective walls or into external dielectrics.

It may also be advantageous to incorporate a coating having an additional functionality into the structure. This may be a coating having the function of blocking radiation of wavelengths in the infrared (for example using one or more silver layers surrounded by dielectric layers, or layers made of nitrides, such as TiN or ZrN, or metal oxides, or steel or an Ni—Cr alloy), having a low emissivity function (for example a doped metal oxide such as SnO₂:F or tin-doped indium oxide ITO, or one or more silver layers), an antifogging function (using a hydrophilic layer), an antisoiling function (a photocatalytic coating comprising TiO₂ at least partially crystallized in the anatase form), or else an anti-reflection multilayer, for example of the Si₃N₄/SiO₂/Si₃N₄/SiO₂ type.

The electrical conductor in layer form may also have a low-emissivity or solar protection function.

The electrical protection system, with or without its power supply, and that part of the structure forming the flat lamp with or without its power supply may form a monolithic assembly, or even an integrated one, that is to say having one element in common and/or the common power supply.

The electrical protection system and that part of the structure forming the flat lamp may also be supplied separately, sold in kit form and ready to be assembled.

Furthermore, the luminous structure may form an integral part of a double glazing unit, as a replacement for one of the glass panes of the double glazing unit, or by being combined with, for example incorporated into, the double glazing unit.

The subject of the invention is also a method of electrically protecting a flat or substantially flat luminous structure with electrodes on the surface generating electric field lines with at least one component perpendicular to the surface, characterized in that an electrical conductor is placed on a dielectric above the electrode which is supplied or capable of being supplied with a high-frequency electromagnetic signal f₀, the electrical conductor is connected to a power supply with a potential V and/or with a frequency f, these being such that the peak value of the external leakage current is equal to 2 mA or less if f is zero, or equal to 0.7 mA or less if f is nonzero.

Other details and features of the invention will become apparent from the detailed description that follows, given with regard to the appended drawings in which:

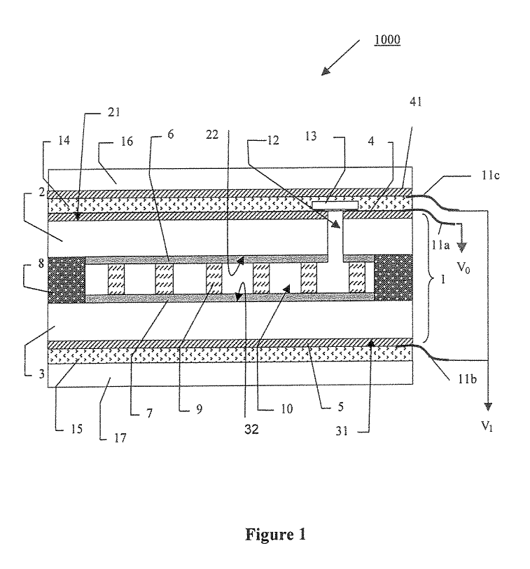

FIG. 1 shows a schematic sectional view of a safe flat lamp according to the invention; and

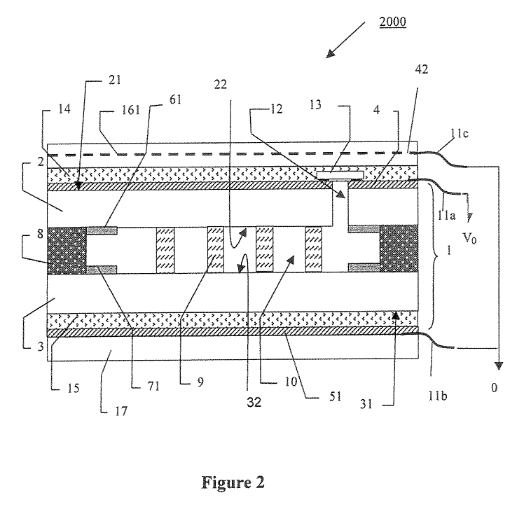

FIGS. 2 to 7 show schematic sectional views of other embodiments of a safe flat lamp according to the invention.

It should be pointed out that, for the sake of clarity, the various elements of the objects shown have not necessarily been drawn to scale.

FIG. 1 shows a flat lamp 1000 consisting of a part 1 formed by two substrates made of glass sheets 2, 3, for example about 4 mm in thickness, having a first face 21, 31 coated with a preferably continuous and homogeneous conductive coating 4, 5 constituting an electrode, and a second face 22, 32 that has a coating 6, 7 of photoluminescent material, which is for example transparent, for example in the form of phosphor particles dispersed in an inorganic matrix, for example based on lithium silicate.

The sheets 2, 3 are brought together so that their second faces 22, 32 or internal faces bearing the photoluminescent material 6, 7 and are assembled by means of a sealing frit 8, the gap between the glass sheets being set (with a value generally less than 5 mm) by glass spacers 9 spaced between the sheets. Here, the gap is around 0.3 to 5 mm, for example 0.4 to 2 mm.

The spacers 9 may have a spherical, cylindrical or cubic shape or another polygonal, for example cruciform, cross section. These spacers may be coated, at least on their lateral surface exposed to the plasma gas atmosphere, with a phosphor identical or different to the phosphor 6, 7.

There is a reduced pressure, generally of the order of one tenth of atmospheric pressure, of a rare gas such as xenon, possibly mixed with neon or helium, in the internal space 10 between the glass sheets 2, 3.

Each electrode is deposited directly on the external face 21, 31 of the substrate 2, 3. Each electrode 4, 5 is preferably a layer of fluorine-doped tin oxide.

As a variant, each electrode may be applied to the substrate in various ways. It may be deposited on the external or internal face of an electrically insulating bearing element, this bearing element being joined to the substrate so that the coating is pressed against the external face 21, 31 of the substrate. This element may for example be a plastic film of the EVA or PVB type, or several plastic films, for example PET, PVB or PU films.

Each electrode may also be in the form of a metal grid integrated into a plastic film or even into the substrate which then forms a reinforced glass.

Each electrode may also be sandwiched between a first electrical insulator and a second electrical insulator, the assembly being joined to the substrate 2, 3. The electrode may for example be inserted between two plastic sheets.

Another combination of electrical insulators is the following: a PVB sheet is taken as first electrical insulator, which will be used to bond the second electrical insulator bearing the electrode, such as a PET sheet, the electrode being between the PVB and the PET sheet.

The electrodes 4, 5 are connected to a high-frequency power supply source via flexible shims 11a, 11b.

The electrode 4 is at a potential V₀ of the order of 1 kV and a high frequency f₀ of 40 to 50 kHz.

The smaller the thickness of the substrate 2, 3 (generally the thickness of dielectric(s) separating the electrodes), for example reduced to 2 or 1 mm, the lower the voltage V₀ has to be, and therefore the more flexible the conditions with respect to V and f for guaranteeing the insulation.

The electrode 5 is at a potential V₁ of around 220 V and a frequency f of 50 Hz.

Placed above this electrode 4 are a dielectric 14 and an electrical conductor 41, this being supplied with power via a flexible shim 11c and connected to the electrode 5. This conductor 41 is for example in the form of a layer of fluorine-doped tin oxide deposited entirely on the internal face of the glass sheet 16, for example 3.85 mm in thickness, or alternatively on a thick plastic support.

For an electrode 4 of 0.36 m² in area and for a power of 100 W, the leakage current measured by placing a continuous metal object of the same area on the 3.85 mm thick glass sheet 16 is about 0.6 mA (peak value).

The dielectric 14 is a capacitive laminating insert, for example a PVB film 1.5 mm in thickness for limiting the capacitance.

Placed on the external face 31 is an appropriate resin or transparent plastic film 15, for example PVB 1.5 mm in thickness, which serves as laminating insert with a glass substrate, for example a 3.15 mm thick glass sheet 17 or alternatively a thick rigid plastic support.

For an electrode 5 with an area of 0.36² and for a power of 100 W, the leakage current measured by placing a continuous metal object of the same area on the 3.15 mm thick glass sheet 17 is about 0.65 mA (peak value).

If the metal object has a smaller area, its leakage current is reduced proportionally.

In a first variant, V₁ is at ground potential provided in one point of the power supply circuit for the lamp, in which case the leakage current is zero.

In a second variant, the electrode 5 and the electrical conductor 41 are not connected. For example, the conductor remains at V₁, while the second electrode is connected to either the 220 V and 50 Hz mains or is grounded.

In the embodiment shown in FIG. 2, the structure 2000 of the lamp basically repeats the structure of FIG. 1, except for:
the electrical conductor 42, which is a grid in a reinforced glass pane 161, the thickness of the glass above the electrode being for example about 2 mm;
the arrangement of the electrode 51 placed on a film, for example a PET film combined with a PVB film, or joining the 3.85 mm thick glass pane 17; and
the opaque photoluminescent material 61, 71 placed only around the border, for differentiated illumination.

The electrode 51 and the conductor 42 are also grounded.

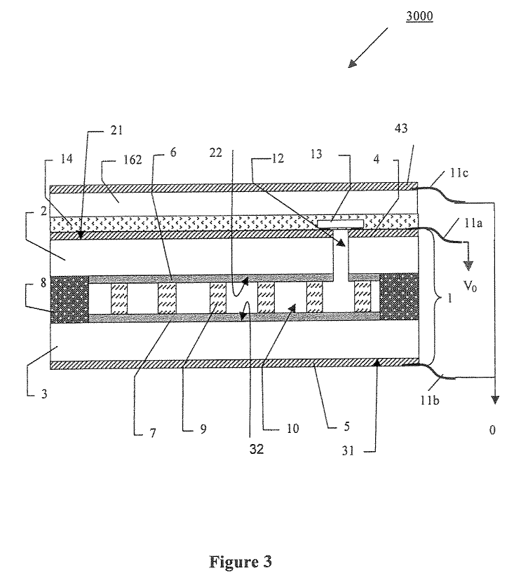

In the embodiment shown in FIG. 3, the structure 3000 of the lamp basically repeats the structure of FIG. 1, except for:
the arrangement of the electrical conductor 43 covering the glass sheet 162, this conductor also possibly being protected by an adhesive film, for example by a polyurethane or polycarbonate film;
the dielectric 14 is a laminating insert 1.5 mm in thickness for example; and
the absence of a laminating glass counterpane and a plastic insert film above the electrode 5.

Since the electrode 5 and the electrical conductor 43 are grounded, the electrical conductor 43 acts as a shield.

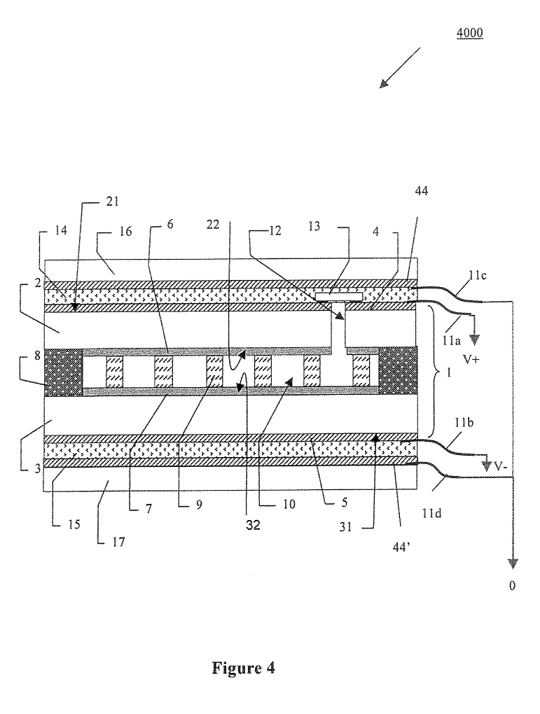

In the embodiment shown in FIG. 4, the structure 4000 of the lamp basically repeats the structure of FIG. 1 except for the electrode 4, which is at a potential V+ of around 300 V and the electrode 5, which is at a potential of opposite sign V− of around 700 V, for a frequency of 50 kHz. In addition, two electrical conductors 44, 44′, in the form of continuous transparent electrically conducting layers separated from the electrodes by dielectrics, which are also laminating inserts, are connected to a ground of the circuit for supplying power to the lamp in order to avoid any leakage current.

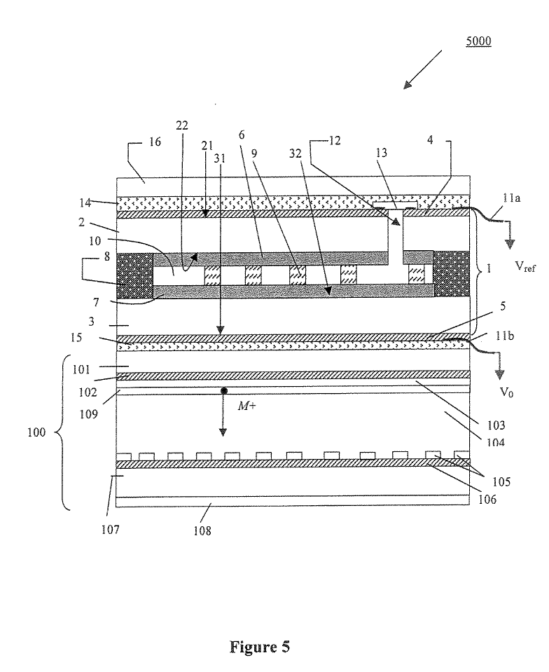

In the embodiment shown in FIG. 5, the structure 5000 of the lamp basically repeats a structure of FIG. 1. However, the electrode 5 is at a potential V₀ of the order of 1 kV and a high frequency f₀ of 40 to 50 kHz, and the electrode 4 is at a potential V_{ref} of around 220 V and a frequency f of 50 Hz.

Joined on top of the electrode 5 is a reversible electrochemical mirror 100, which renders the structure safe.

This reversible electrochemical mirror comprises, in succession:
a glass substrate 101 or, as a variant, a transparent plastic substrate, such as a PET-based material or any composite substrate;
a first electrode 102;
first nucleation sites 103, for example made of platinum;
an electrolyte 104, for example a mixture of AgI and LiBr in a y-butyrolactone solvent;
second nucleation sites 105, for example made of platinum;
a second electrode 106;
a transparent substrate, preferably a glass sheet 107 or, as a variant, a transparent plastic substrate or any composite substrate, whether flexible or rigid; and
optionally, a low-emissivity or solar-protection layer 108.

The first nucleation sites 103 are close to one another, whereas the second nucleation sites 105 are placed away from one another. Atoms M+ of a metal material, for example silver, are capable of forming, by electrodeposition, a reflecting surface 109 or a semireflecting (intermediate state) surface on the first sites 103, or a substantially transparent surface (not shown), in the form of conducting islands, on the second sites 105.

Control means (not shown) are provided for controlling the level of reflection of the reflecting surface, by adjusting the voltage, by measuring the amount of current or by electrical resistance measurements.

Since the electrode 106 is grounded (not shown), the leakage current on the electrode 5 side is therefore zero.

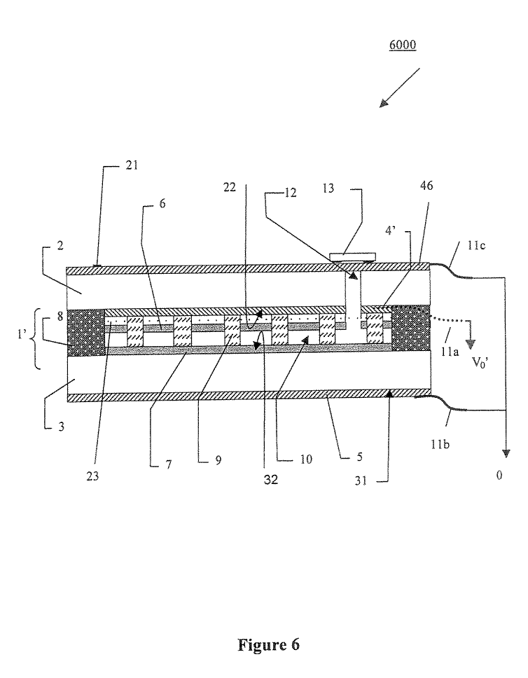

In the embodiment shown in FIG. 6, the structure 6000 of the lamp partly repeats the structure of FIG. 1. However, the electrode 4′ is a metal layer placed on the internal face 22 of the glass substrate 2. A thin dielectric 23, which serves as a reflector, for example made of alumina, is inserted between this electrode 4′ and the photoluminescent material 6. This lamp provides unidirectional illumination.

The electrode 4′ is for example at a potential V₀′ of around 850 V and a high frequency f₀ of 40 to 50 kHz.

For the electrical insulation, the electrical conductor 46, for example made of metal, is deposited on the external face 21 of the glass substrate 2 and is connected to the electrode 5, which is grounded.

The smaller the thickness of the dielectric 23, the lower the voltage V₀′ must be, and therefore the insulation criteria are less drastic.

In a variant, the electrode 5 is connected to the mains (220 V/50 Hz), just like the electrical conductor 46, and added on top of this electrode and the electrical conductor are laminating glass counterpanes or an all-plastic dielectric in order to limit the leakage currents.

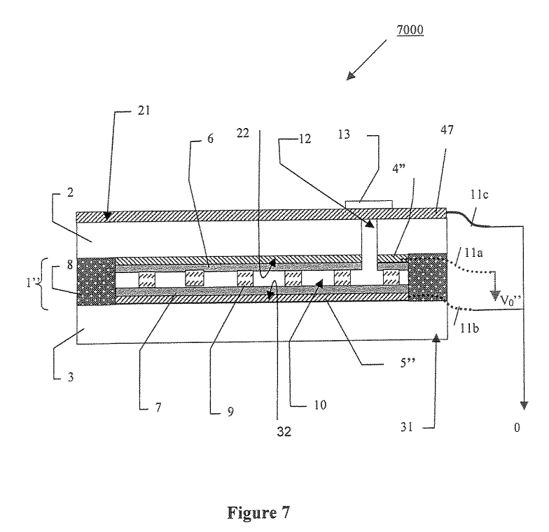

In the embodiment shown in FIG. 7, the structure 7000 of the lamp partly repeats the structure of FIG. 6. However, the electrode 4″ is a transparent electrically conducting layer and the electrode 5″ is placed on the internal face 32 of the glass substrate 3. The photoluminescent material 6 is placed directly on the electrode 4″.

The electrode 4″ is a potential V₀″ of around 500 to 700 V and at a high frequency f₀ of 40 to 50 kHz.

For the electrical insulation, the electrical conductor 47 is deposited on the external face 21 of the glass substrate 2 and is connected to the electrode 5″, which is grounded.

In a variant, the electrode 5″ is connected to the mains (220 V/50 Hz), just like the electrical conductor 47, and added on top of the electrical conductor 47 is a laminating glass counterpane or an all-plastic dielectric in order to further limit the leakage current.

The examples that have just been described in no way limit the invention.

All assembly variants and dissymmetries are possible both as regards the electrodes and the electrical conductor or conductors for safety, and, as the case may be, the dielectric covering these conductors when at least one dielectric separates the conductor(s) from the electrodes.

The luminous structure may form an integral part of a double glazing unit, for example as a replacement for one of the glass panes of the double glazing unit. In this configuration, the electrical conductor may also be on the remaining glass pane of the double glazing unit.

In the case of activation by a plasma gas, a differentiated distribution of the photoluminescent material in certain regions makes it possible to convert the energy of the plasma into visible radiation only in the regions in question, so as to constitute luminous regions (which are themselves opaque or transparent depending on the nature of the photoluminescent material) and juxtaposed permanently transparent regions.

The luminous region may also form a network of geometrical features (lines, studs, dots, squares or features of any other shape) and the spacings between features and/or the size of the features may be varied.

Moreover, the luminous source may be a plasma gas.

The walls may be of any shape: an outline may be polygonal, concave or convex, especially square or rectangular, or curved, with a constant or variable radius of curvature, especially a round or oval shape.

The walls may be flat or domed, preferably held at a constant distance apart.

The walls may be glass substrates exhibiting an optical effect, especially walls that are colored, decorated, structured, diffusing, etc.

The structure may be sealed by a mineral material (for example a glass frit), using a substantially transparent material (glass, etc.), or with an adhesive (silicone).

1-18. (canceled)

19. A flat or substantially flat luminous structure comprising:
first and second walls facing each other and defining an internal space that includes a light source;
first and second electrodes for the light source, which generate electric field lines with at least one component perpendicular to the first and second electrodes, the first electrode supplied or configured to be supplied with a high frequency electromagnetic signal;
as an outer covering for the first electrode, an electrical safety system that includes an electrical conductor separated from the first electrode by a dielectric, the conductor connected or configured to be connected to a power supply with a potential V and/or with a frequency f, V and f being adjusted so that a peak value of external leakage current is equal to 2 mA or less if f is zero, or equal to 0.7 mA or less if f is nonzero.

20. The luminous structure as claimed in claim 19, wherein the first and second electrodes are associated with the first and second walls respectively, the first and second walls being glass sheets.

21. The luminous structure as claimed in claim 19, wherein the dielectric comprises at least one of the following elements:
a glass element, or a glass sheet;
an element made of a polymer material, polyethylene terephthalate, polyvinyl butyl or ethylene vinyl acetate, by themselves or in combination;
a gas, or air,
or a combination of these elements.

22. The luminous structure as claimed in claim 19, wherein the dielectric is substantially or overall transparent.

23. The luminous structure as claimed in claim 19, wherein the electrical conductor is substantially or overall transparent.

24. The luminous structure as claimed in claim 19, wherein the potential V is at ground.

25. The luminous structure as claimed in claim 23, wherein the electrical conductor is a layer deposited on the dielectric or a layer deposited on an internal or external face of a glass substrate.

26. The luminous structure as claimed in claim 23, wherein the electrical conductor is a grid.

27. The luminous structure as claimed in claim 23, wherein the electrical protection system comprises a dielectric located on top of the electrical conductor, and the potential V is equal to 400 V or less and/or the frequency f is equal to 100 Hz or less, or 60 Hz or less.

28. The luminous structure as claimed in claim 27, wherein the potential V is equal to 220 V or less and f is equal to 50 Hz or less.

29. The luminous structure as claimed in claim 27, wherein the covering dielectric comprises a glass sheet, or a glass sheet having a thickness of 4 mm or less.

30. The luminous structure as claimed in claim 27, wherein the electrical conductor is a layer deposited on the internal face of the covering dielectric.

31. The luminous structure as claimed in claim 27, wherein the electrical conductor is a grid incorporated into a dielectric.

32. The luminous structure as claimed in claim 19, wherein the second electrode is connected to the electrical conductor.

33. The luminous structure as claimed in claim 19, wherein the second electrode is supplied or configured to be supplied with a high frequency electromagnetic signal (V−), and the luminous structure includes another electrical safety system associated with the second electrode.

34. The luminous structure as claimed in claim 19, wherein the electrical protection system forms part of an electrically controllable device, or an electrically controllable device having variable optical properties.

35. The luminous structure as claimed in claim 19, wherein the first electrode is either a grid, or a grid incorporated into the first wall, or comprises an electrically conducting layer placed on the internal or external face of the first wall or on the internal face of the dielectric.

36. A method of electrically protecting a flat or substantially flat luminous structure with electrodes generating electric field lines with at least one component perpendicular to the electrodes, comprising:
placing an electrical conductor on a dielectric above the electrode, which is supplied or configured to be supplied with a high frequency electromagnetic signal; and
connecting the electrical conductor to a power supply with a potential V and/or with a frequency f, V and f being such that a peak value of external leakage current is equal to 2 mA or less if f is zero, or equal to 0.7 mA or less if f is nonzero.
